(19) United States
(12) Patent Application Publication
(10) Pub. No.: US 2014/0286373 A1
(43) Pub. Date: Sep. 25, 2014

(54) Thermal Resistance Measuring Device

(71) Applicant: Cambria Limited, Ashurst (NZ)

(72) Inventors: Wayne Carl Thresher, Ashhurst (NZ); Clinton McKinnon, Bulls (NZ)

(21) Appl. No.: 14/353,226

(22) PCT Filed: Oct. 5, 2012
(86) PCT No.: PCT/US12/59105

§ 371 Date: Apr. 21, 2014

Related U.S. Application Data
(60) Provisional application No. 61/627,845, filed on Oct. 20, 2011.

(51) Int. Cl. G01K 17/06

(52) U.S. Cl. CPC G01K 17/06
USPC 374/29

(57) ABSTRACT

Contemplated devices and methods allow for simple and accurate measurement of static and dynamic heat flux and heat capacity of a structure in situ. Especially preferred devices and methods use a thermally equilibrated housing that encloses a thermoelectric sensor and an associated microprocessor and external temperature sensor.

This application claims priority to our copending U.S. provisional application with the Ser. No. 61/627845, which was filed Oct. 20, 2011.

### FIELD OF THE INVENTION

The field of the invention is devices and methods of in situ measurement of heat flux through a building envelope.

### BACKGROUND OF THE INVENTION

Heat flux determination is an important tool in the construction and other industries to evaluate insulative properties and heat loss in various structures, and numerous devices and methods are known to measure heat flux. For example, ASTM C1363-11 describes a standard test method for thermal performance of building materials and envelope assemblies in which a hot box device is used to provide a heat source and a thermocouple or thermopile. The hot box is typically used in conjunction with another thermal sensor or thermocouple/thermopile that is placed opposite the structure to be measured. Such measurements are often relatively accurate, however, demand in most cases significant space and equipment and can therefore generally not be used in situ. Such is particularly inconvenient where heat flux measurement is performed to determine if a retrofit of a residential or industrial building in use is advisable or economically sensible.

Additional difficulties can be encountered with sizing of the hot box as heat flux from a hot box is often not perpendicular in the vicinity of the borders of the hot box. For example, a relatively small hot box will tend to measure heat flux within the wall, while a relatively large box requires proper placement of the thermocouple/thermopile to avoid measurement of heat flux in directions not perpendicular to the wall. Moreover, and depending on the type and number of thermocouples or thermopiles, sensitivity is relatively moderate and demands relatively high temperatures within the hot box.

To avoid difficulties associated with the use of a hot box, systems and devices have been developed that employ a sensor sandwich in which a heat plate is positioned between two heat flux sensors as described in EP 0 065 433. Alternatively, multiple thermocouples with different time constants can be used as described in WO 2011/040634. Heat flux can also be measured using multiple thermometers at the inside and outside of a wall together with an ambient temperature probe to develop a temperature profile over time as disclosed in WO 2012/049417. While such devices and methods generally improve portability, various other disadvantages arise. For example, measurement may require a significant period of time and equipment and/or calculation may be relatively complex or inaccurate.

In still further known systems and methods, heat flux across a structure is determined in a thermographic approach as discussed in WO 2011/128927. Thermographic determination is particularly advantageous as no physical equipment is thermally coupled to the wall or other structure. However, the equipment is frequently very expensive and analysis may be compounded by change in environmental conditions. Moreover, thermographic data is in most cases qualitative and unable to provide an accurate and precise quantitative assessment of thermal resistance.

Thus, even though numerous devices and methods for measuring heat flux are known in the art, there is still a need to provide improved devices and methods for measuring heat flux, especially for in situ use in real-time.

### SUMMARY OF THE INVENTION

The present invention is directed to devices and methods for determination of heat flux across a structure having (typically opposing) first and second surfaces. In particularly preferred methods and devices, the heat flux sensor is in a housing that avoids drawbacks normally associated with a hot box and that allows simple and accurate in situ measurement in real-time.

In one aspect of the inventive subject matter, a heat flux sensor for determination of heat flux across a structure that has a first and a second surface. Especially contemplated devices will include a thermally equilibrated housing with an engagement surface that contacts a portion of the first surface, wherein the housing further retains a heat flux transducer (preferably a Peltier element, most preferably comprising bismuth telluride), typically via a biasing element that is coupled to the housing and the transducer to allow for conductive transfer of heat from the first surface to the transducer when the engagement surface contacts the first surface. It is further generally preferred that the heat flux transducer can bidirectionally measure heat flux, and that the housing is equilibrated via a thermal control device that is coupled to the housing. Particularly preferred thermal control devices will maintain a thermal equilibrium between the space enclosed by the housing and the space outside the housing.

It is still further generally preferred that the thermal control device maintains the thermal equilibrium such that the space enclosed by the housing and the space outside the housing have the same temperature, and that the thermal control device applies negative air pressure to the space enclosed by the housing in an amount effective to retain the device on the first surface. Alternatively, it is also contemplated that the thermal control device maintains the thermal equilibrium such that the space enclosed by the housing and the space outside the housing have a predetermined and constantly different temperature over time (e.g., to maintain a predetermined temperature difference between the first and second surface), or a predetermined and constantly varying temperature over time (e.g., where the temperature is adjusted as a function of previously determined heat flux). Where the temperatures of the inside of the housing and the outside of the housing are not the same, it is especially preferred that the heat flux transducer is sized and positioned in the housing such as to only measure heat flux that is substantially perpendicular to the first and second surfaces.

In another preferred aspect of the inventive subject matter, a heat flux sensor for determination of heat flux across a structure with first and second surfaces includes a housing that has an engagement surface that sealingly contacts a portion of the first surface, wherein the housing further retains a heat flux transducer(preferably a Peltier element, most preferably comprising bismuth telluride). In especially preferred aspects, a biasing element (e.g., comprising a spring or elastic band) is coupled to the housing and the heat flux transducer such that heat is conductively transferred from the first surface to the heat flux transducer when the engagement surface contacts the first surface, and that the heat flux transducer can bidirectionally measure the heat flux. It is still further preferred that in such devices a ventilation device (e.g., electric fan) is included that renders the temperature of the space enclosed by the housing and the space outside the housing substantially identical, and that also reduces pressure in the space enclosed by the housing to so self-supportingly retain the heat flux sensor on the first surface.

Most preferably, the engagement surface has a minimum distance of at least 100 mm from the heat flux transducer, and contemplated devices will further comprise a (or be operationally coupled to) processing unit that calculates the heat flux across the structure using data from the heat flux transducer, data from a first temperature sensor measuring the temperature in the space enclosed by the housing, and data from a second temperature sensor measuring the temperature at the second surface.

Therefore, and viewed from a different perspective, the inventors also contemplate a method of improving measurement of heat flux across a structure having first and second opposing surfaces, wherein heat flux is measured using a heat flux transducer enclosed in a housing. In particularly preferred methods, the heat flux sensor device has a housing with an engagement surface that contacts at least a portion of the first surface of the structure, wherein the housing is further configured to retain a heat flux transducer. A biasing element is then coupled to the housing and the heat flux transducer such that heat is conductively transferred from the first surface to the heat flux transducer when the engagement surface contacts the first surface, wherein the heat flux transducer is capable to bidirectionally measure the heat flux. The housing is then thermally equilibrated by maintaining the temperature of the space enclosed by the housing the same as the temperature of the space outside the housing.

Most preferably, the step of thermally equilibrating the housing is done by a ventilation device that also reduces a pressure in the space enclosed by the housing to thereby retain the heat flux sensor on the first surface. Moreover, and while not limiting the inventive subject matter, it is generally preferred that the heat flux transducer is a Peltier element, and most preferably comprises bismuth telluride, and that the biasing element comprises a spring or an elastic band. In especially preferred methods, heat flux is continuously and in real-time calculated using (a) data from the heat flux transducer, (b) a first temperature sensor measuring the temperature in the space enclosed by the housing, (c) a second temperature sensor measuring the temperature at the second surface.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an exemplary schematic illustration of a heat flux sensor according to the inventive subject matter.

FIG. 2A is a photograph depicting an inside view of an exemplary heat flux sensor according to the inventive subject matter, and FIG. 2A is a photograph depicting an outside view of the heat flux sensor of FIG. 2A while self-supported on a wall.

FIG. 3A is an exemplary illustration of placement of thermoelectric elements within a housing, and FIGS. 3B and 3C are graphs depicting performance results for the elements as a function of horizontal and vertical placement, respectively.

### DETAILED DESCRIPTION

The inventors have discovered that heat flux across a structure can be measured in situ in a simple and accurate manner using a heat flux transducer that is placed in a housing that is configured to avoid the drawbacks normally associated with a hot box. Most advantageously, the measurement can be performed in real-time over any desired period of time at variable conditions at one side (or both sides) of the structure. Viewed from a different perspective, it should be appreciated that contemplated devices provide significant improvement over many aspects of heretofore known devices, particularly with respect to in situ use, portability, and accuracy, which is at least in part facilitated by taking advantage of the Seebeck effect of Peltier elements where such elements are used “in reverse”.

In particularly preferred methods and devices, the heat flux sensor is a thermoelectric sensor (Peltier element), which provides various advantages that are normally not achieved using the currently used thermopile or thermocouple. For example, the temperature difference across the device (which is proportional to the heat flux flowing through the device) creates an electrical signal which can be measured, which means that the size of the signal is a direct function of the length of the device rather than the thickness (as is the case with a thermopile or thermocouple). Thus, it should be appreciated that the heat flux sensor can be configured to have a small thickness, which improves the response time of the signal, while at the same time a large signal can be created by increasing the length of the sensor. Indeed, compared to a thermopile or thermocouple having the same area, a transverse thermoelectric heat flux sensor will have a 100-1000-fold higher sensitivity. Consequently, measurement times can be significantly reduced, and/or signal-to-noise ratio will dramatically increase.

In addition to the above advantages, it should also be appreciated that the sensitivity of the thermoelectric sensor will also allow to reduce, or even entirely eliminate the need for a heat source in the housing. While heretofore known hot box devices require a heat source to provide a sufficiently large thermal gradient for the thermopile or thermocouple to generate a reasonably useful signal, the ultra-sensitive thermoelectric sensor will generate sufficiently strong signals without the need for a heat source. Indeed, and as further discussed below in more detail, the housing can be thermally equilibrated with the environment to so virtually turn the environment into a hot box while the thermal gradient between the two sides of the wall or other structure (typically at least 5° C., more typically at least 10° C., most typically at least 15° C.) will typically be sufficient for signal generation. In less preferred aspects, it should be noted however, that thermocouples or thermopiles may also be used with suitably high amplification of the signal generated by the thermocouple or thermopile. Likewise, and as also further discussed in more detail below, a heat source may be included in the housing to so generate a constant temperature within the housing, or to keep a constant temperature differential between within the housing and the environment opposite the wall or other structure (in such case, the heat source is controlled via a control circuit that receives data or other signals representative of the ‘outside’ temperature).

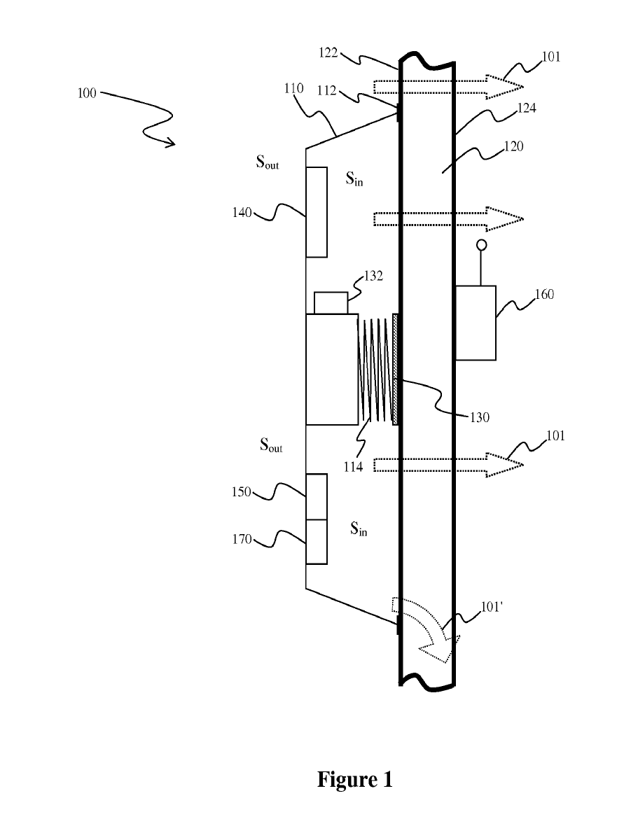

One exemplary heat flux sensor is schematically illustrated in FIG. 1. Here, a heat flux sensor (100) for determination of a heat flux (101) across a structure (120) that has first (122) and second (124) surfaces includes a thermally equilibrated housing (110) with an engagement surface (112). The engagement surface is preferably configured to contact at least a portion of the first surface (122) of the structure (120), and the housing retains a heat flux transducer (130). A biasing element (114) is coupled to the housing (110) and the heat flux transducer (130) to press the transducer to the first surface such that heat is conductively transferred from the first surface to the heat flux transducer when the engagement surface contacts the first surface. In the example of FIG. 1, the heat flux transducer is a thermoelectric sensor and can measure heat flux in both directions. To maintain the housing thermally equilibrated, a thermal control or venting device (140) is coupled to the housing, and the thermal control device operates to maintain a thermal equilibrium between a space enclosed by the housing (Sᵢₙ) and a space outside (Sₒᵤₜ)the housing. In this instance, the thermal control device operates to keep the temperature of the space enclosed by the housing (Sᵢₙ) the same as the temperature in the space outside the housing.

Most typically, contemplated devices will further include a processing unit (150) that is configured to calculate heat flux across the structure using data from the heat flux transducer (130), data from the first temperature sensor (132) measuring temperature in the space enclosed by the housing, and data from a second temperature sensor (160) measuring temperature at the second surface. Thus, the processing unit will continuously and in real-time calculate heat flux across the structure using data from the heat flux transducer, data from a first temperature sensor measuring temperature in the space enclosed by the housing, and data from a second temperature sensor measuring temperature at the second surface. Most typically, the first temperature sensor is located in the housing, while the second temperature sensor is placed on the second surface (124) in a position opposite the heat flux transducer. Where desired, an additional heat source (170) is included that is typically controlled by the processing unit (150).

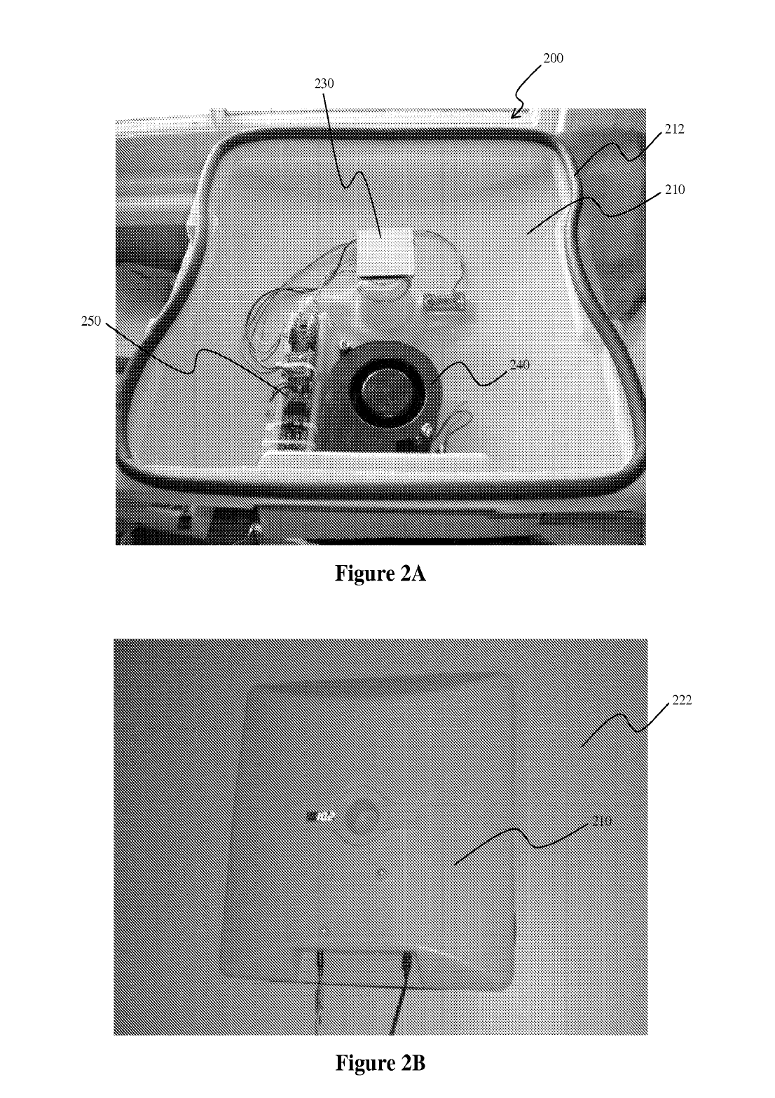

An exemplary device is depicted in the photographs of FIG. 2A and 2B where the device (200) is attached to a wall (222) in a self-supporting manner. Here an electric fan (240) located within the housing (210) is used to generate sufficient negative pressure to maintain the device via sealing engagement surface (212) on the wall. The heat flux transducer (230) is coupled to the housing (210) via a spring that ensures mechanical and conductive thermal contact to the wall (222). Processing unit (250) is coupled to the heat flux transducer, first and second temperature sensors, and optionally thermal control or venting device (240).

Thus, it should be appreciated that in most preferred aspects of the inventive subject matter all components (minus the second thermal sensor) are integrated within the footprint of the housing. Such arrangement is not only visually attractive, but also allows for simple installation by lay people not familiar with the equipment. Moreover, due to the relatively small footprint, typically less than 50 cm in the longest dimension, even more typically less than 40 cm in the longest dimension, and most typically less than 30 cm in the longest dimension, the weight of the housing and components within the housing is suitable for a self-sustaining mounting via the thermal control or venting device.

As noted before, the thermal control/venting device, in conjunction with the sealing surface is also used to remove heat from the housing and allow ambient temperature air to replace the inside air at a rate effective to maintain the temperatures substantially the same and homogenous within the housing. Moreover, it should be noted that the thermal control or venting device also ensures continuous motion of air flow over the heat flux transducer, which allows for a more steady temperature environment, and with that more accurate heat flux signal. Such continuous air flow is also advantageous where the housing is heated by a heat source, as a heat source in a relatively low-volume housing may generate a heat gradient that would negatively affect the heat flux signal from the heat flux transducer. Alternatively, however, it is noted that continuous or discontinuous air flow within the housing may also be realized using a separate device (e.g., propeller).

Particularly preferred thermal control/venting device will be configured such that the thermal control/venting device will allow removal of air from within the housing at a rate sufficient to mount the device in a self-supporting manners only due to negative pressure in the housing. It was unexpectedly found that the heat produced by the operation of the thermal control/venting device is readily removed from the housing without production of an adverse effect on the heat flux signal, and that the thermal control/venting device positively affects the signal stability. Most typically, the thermal control/venting device is operated in continuous mode. However, and especially where the device is maintained in position with a mechanical (e.g., nail, screw, latch, etc.) or chemical fastener (e.g., glue, adhesive tape, etc.), operation of the thermal control/venting device may be intermittent, or even discontinued (particularly where no heat source is included). Thus, the thermal control/venting device may also be employed as an air movement device only that assists in homogenous heat distribution within the device. With respect to control of operation of the thermal control or venting device it should be appreciated that the control may be performed using the processing unit, or via an independent control mechanism.

With respect to the housing it is typically preferred that the housing is fabricated from a light-weight material, typically a polymeric material. It should also be appreciated that the material need not necessarily be a thermally insulating material or comprise a thermally insulating material as in at least some aspects a temperature gradient between the outside and the inside the housing is actively avoided. On the other hand, where the device includes a heat source, the housing may be fabricated from or comprise a thermally insulating material (e.g., foamed polymer, mineral wool, etc.). Furthermore, and as already noted above, it is generally preferred that the housing has a thickness of less than 20 cm, and more typically less than 10 cm, while the largest remaining dimensions (width and length) are preferably between 10 cm and 50 cm, and most preferably between 20 and 40 cm.

Particularly preferred engagement surfaces will be continuous surfaces around the perimeter of the footprint and configured such that the engagement surface forms a seal sufficient to allow self-supporting affixing of the device to the wall upon partial evacuation of the space inside the housing. Therefore, polymeric materials (optionally foamed as open- or closed-cell foam) and rubber materials are especially preferred. However, in yet further contemplated aspects, the engagement surface may merely be formed by an edge of the housing, or formed from a material that is suitable for contacting an interior wall of a residential building without marking or marring. Such surface may or may not be sealing and it should be noted that where the device is employed without a heat source, the engagement surface and/or the housing may have openings to further allow thermal exchange and thermal equilibration with the environment.

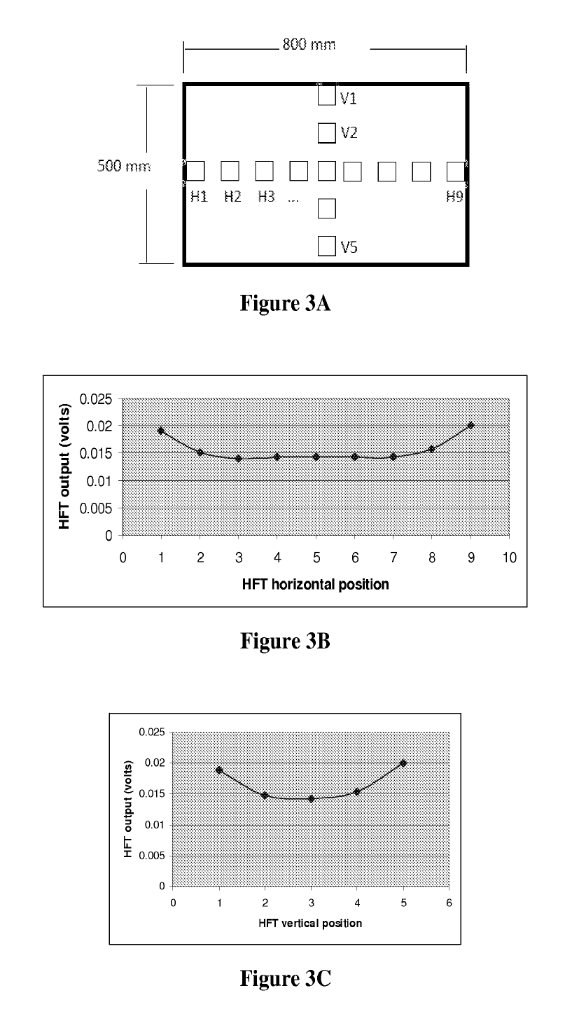

Placement of the heat flux transducer is most preferably at or near the center of the footprint of the device to so avoid measurement of heat flux that is not perpendicular to the structure that is under investigation. More specifically, and to investigate optimal geometry for positioning of the heat flux transducer, the inventors prepared a model wall with a slightly cooled interior (i.e., second surface cooled to about 17° C.). An arrangement of several heat flux transducers was then positioned against the warm side of the wall ranging from the center of the footprint to the sides of the box as schematically illustrated in FIG. 3A. The temperature inside the hotbox was controlled to maintain a temperature difference of approximately 18 to 20° C., and a small fan circulated the air in the hot box to keep the temperature uniformly warm inside the box. The voltage output of all 14 heat flux transducers was logged and averaged over a 24 hour period, and the results were then plotted on a scatter plot with position on the X-axis and average voltage on the y-axis. FIG. 3B depicts the results for horizontal arrangement, and FIG. 3C depicts the results for vertical arrangement. As is readily apparent, the heat flux was perpendicular to the plane of the test wall for most of the transducer positions. Only positions near the edge of the hotbox, within 100 mm of the edge, were shown to experience non-perpendicular heat flux. Thus, it is contemplated that the minimum distance of the heat flux transducer from the edge of the housing is preferably at least 100 mm A schematic illustration of the heat flux is also seen in the dotted arrows of FIG. 1.

In especially preferred aspects of the inventive subject matter, the heat flux transducer is a Peltier or other thermoelectric element, typically with a generally flat shape having a thickness of less than 10 mm, more typically less than 6 mm, most typically about 5 mm, and in some cases 5-3 mm, or even less. It is still further preferred that the heat flux transducer has a square or rectangular geometry with a length of between 10 to 100 mm For example, a heat flux transducer could have a square geometry of between 30 to 60 mm side length. Where increased signal strength is preferred, the heat flux transducer may also be extended in one direction to have a side length ratio of between 1:1.1 and 1:1.5, more typically 1:1.5 and 1:2, or even 1:2.1 or even higher.

It is further especially preferred that heat flux transducer is a Peltier element and most preferably comprises a bismuth telluride (Bi₂Te₃; bismuth-(III)-telluride) or other suitable thermoelectric material rather than thermopile or thermocouple. It should be particularly noted that use of a thermoelectric material will allow bidirectional measurement of flow of heat as the signal is simply inverted upon reversal of the heat flux. Such advantage cannot be readily achieved with a thermo couple or thermopile. However, it should be noted that use of a thermopile or thermocouple is not excluded from the scope of the inventive subject matter presented herein. In such case, it is contemplated that the housing will include at least one heat source to increase the temperature difference between the two surfaces of the structure to be measured. Moreover, where a thermopile or thermocouple is used, it is generally contemplated that a signal amplification circuit will be required to calculate a heat flux signal.

Depending on the type and configuration of the heat flux transducer, it is generally contemplated that the nature and configuration of the biasing element may vary considerably so long as the biasing element will allow placement of the heat flux transducer onto the first surface such that heat is conductively transferred from the first surface to the heat flux transducer, typically when the engagement surface contacts the first surface. Thus, and among various alternative options, the biasing element may be a resilient structure to press the heat flux transducer to the first surface. For example, suitable biasing elements include one or more springs (e.g., coiled or flat), an elastic band, and even a mechanism that forces the heat flux transducer against the first surface after the engagement surface has contacted the first surface (e.g., via a levered or screw-type mechanism).

To determine heat flux across the structure, a second temperature sensor is preferably provided that is suitable for removable attachment to the second surface and that most preferably provides a temperature signal (e.g., via wireless or wired communication) to the processing unit. In especially preferred aspects, the second temperature sensor is attachable to a wall (e.g., via vacuum, mechanical, or chemical fasteners) and is placed opposite the heat flux transducer on the second surface. Alternatively, numerous other second temperature sensors are also deemed suitable, so long as such sensors provide an accurate temperature read out (e.g., within 0.5° C. or less tolerance) and so long as such read out can be recorded or transferred for calculation with the measured heat flux signal. With respect to the first temperature sensor that measures the temperature at or near the first surface in the space enclosed by the housing, it is noted that all known temperature sensors are deemed suitable and especially include those that generate an electric signal that is representative of the measured temperature. Thus, heat flux and heat capacity of a structure (and especially dynamic heat flux and heat capacity over time) can be readily calculated from the first and second temperature readings at a time, together with the signal from the heat flux transducer.

Therefore, it should be appreciated that the systems and methods contemplated herein will allow various modes of operation for simple and effective determination of heat flux and heat capacity across a structure. Most preferably, operation in most instances is a stand-alone mode without use of a heat source, only measuring first and second temperatures at first and second surfaces, together with the measured heat flux. Alternative options include those in which the system is configured to maintain a predetermined temperature within the housing and/or in which the system is configured to maintain a predetermined temperature gradient between the temperature within the housing and the temperature measured at the second surface. Most typically, where temperature in the housing is actively managed, it is noted that the temperature is preferably controlled by the same processing unit, which also preferably calculates and provides and output of the static and/or dynamic heat flux and/or heat capacity of the structure. Thus, contemplated systems also include a kit in which a heat flux sensor according to the inventive subject matter is provided together with a temperature sensor suitable for functional cooperation with the heat flux sensor. Lastly, it is noted that devices and methods presented herein are particularly suitable for in situ testing as described in ASTM standard 1046.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A heat flux sensor for determination of a heat flux across a structure having first and second surfaces, comprising:
a thermally equilibrated housing having an engagement surface that is configured to contact a portion of the first surface of the structure, wherein the housing is further configured to retain a heat flux transducer;
a biasing element coupled to the housing and the heat flux transducer such that heat is conductively transferred from the first surface to the heat flux transducer when the engagement surface contacts the first surface;
wherein the heat flux transducer is configured to bidirectionally measure the heat flux;
wherein the thermally equilibrated housing is equilibrated via a thermal control device that is coupled to the housing; and
wherein the thermal control device is configured to maintain a thermal equilibrium between a space enclosed by the housing and a space outside the housing.

2. The heat flux sensor of claim 1, wherein the thermal control device is configured to maintain the thermal equilibrium such that the space enclosed by the housing and the space outside the housing have the same temperature.

3. The heat flux sensor of claim 2, wherein the thermal control device is also configured to apply a negative air pressure to the space enclosed by the housing.

4. The heat flux sensor of claim 1, wherein the heat flux transducer comprises a Peltier element.

5. The heat flux sensor of claim 4, wherein the Peltier element comprises bismuth telluride.

6. The heat flux sensor of claim 1, further comprising a heat source that is configured to maintain a predetermined temperature within the space enclosed by the housing.

7. The heat flux sensor of claim 1, further comprising a heat source that is configured to maintain a predetermined temperature gradient between the space enclosed by the housing and a temperature at the second surface.

8. The heat flux sensor of claim 1, wherein the heat flux transducer is sized and positioned in the housing such as to only measure heat flux that is substantially perpendicular to the first and second surfaces.

9. A heat flux sensor for determination of a heat flux across a structure having first and second surfaces, comprising:
a housing with an engagement surface that is configured to sealingly contact a portion of the first surface of the structure, wherein the housing is further configured to retain a heat flux transducer;
a biasing element coupled to the housing and the heat flux transducer such that heat is conductively transferred from the first surface to the heat flux transducer when the engagement surface contacts the first surface;
wherein the heat flux transducer is configured to bidirectionally measure the heat flux; and
a ventilation device that is configured to render a temperature of a space enclosed by the housing and a space outside the housing substantially identical, and to reduce pressure in the space enclosed by the housing to thereby self-supportingly retain the heat flux sensor on the first surface.

10. The heat flux sensor of claim 9, wherein the biasing element comprises a spring or an elastic band.

11. The heat flux sensor of claim 9, wherein the heat flux transducer comprises a Peltier element.

12. The heat flux sensor of claim 11, wherein the Peltier element comprises bismuth telluride.

13. The heat flux sensor of claim 9, wherein the ventilation device comprises an electric fan.

14. The heat flux sensor of claim 9, wherein the engagement surface has a minimum distance of at least 100 mm from the heat flux transducer.

15. The heat flux sensor of claim 9, further comprising a processing unit configured to calculate heat flux across the structure using data from the heat flux transducer, data from a first temperature sensor measuring temperature in the space enclosed by the housing, and data from a second temperature sensor measuring temperature at the second surface.

16. A method of improving measurement of heat flux across a structure having first and second opposing surfaces, wherein heat flux is measured using a heat flux transducer enclosed in a housing, comprising:
providing a housing having an engagement surface that is configured to contact a portion of the first surface of the structure, wherein the housing is further configured to retain a heat flux transducer;
coupling a biasing element to the housing and the heat flux transducer such that heat is conductively transferred from the first surface to the heat flux transducer when the engagement surface contacts the first surface;
wherein the heat flux transducer is configured to bidirectionally measure the heat flux; and
thermally equilibrating the housing by maintaining a temperature of a space enclosed by the housing the same as a temperature of a space outside the housing.

17. The method of claim 16 wherein the step of thermally equilibrating the housing is performed using a ventilation device that further reduces a pressure in the space enclosed by the housing to thereby retain the heat flux sensor on the first surface.

18. The method of claim 16 wherein the heat flux transducer comprises bismuth telluride.

19. The method of claim 16 wherein the biasing element is spring or an elastic band.

20. The method of claim 16 further comprising a step of continuously and in real-time calculating heat flux across the structure using data from the heat flux transducer, data from a first temperature sensor measuring temperature in the space enclosed by the housing, and data from a second temperature sensor measuring temperature at the second surface.
